(19) United States
(12) Patent Application Publication
(10) Pub. No.: US 2006/0059569 A1
(43) Pub. Date: Mar. 16, 2006

(54) Application and device user verification from an operating system-based authentication service

(75) Inventors: Mukkul Dasgupta, Bellevue, WA (US); Igor Dvorkin, Seattle, WA (US); George Joy, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/927,999

(22) Filed: Aug. 27, 2004

(51) Int. Cl. H04L 9/32

(52) U.S. Cl. 726/28

(57) ABSTRACT

Methods and systems provide an operating system-based user authentication service that operates independently of a computing device or software application requiring verification of a user's identity to operate the device or utilize functionality of the software application. A given software application for providing functionality to a user or for allowing a user to operate a desired computing device calls the operating system-based authentication service for verifying the user's identity to use the software application functionality or to operate the desired computing device. If the user's identity is verified by the authentication service, the application is notified, and the user is allowed to operate the device or utilize the desired application functionality.

### FIELD OF THE INVENTION

The present invention generally relates to verification of user identity to utilize software applications and computing devices. More particularly, the present invention relates to requesting verification of user identity to use functionality of a given application or device from an operating system-based authentication service.

### BACKGROUND OF THE INVENTION

Owners and operators of many software applications and computing devices often require user verification before a user is allowed to access certain software functionality or utilize certain computing devices. For example, a corporate owner/operator of an electronic mail system may require user verification for accessing electronic mail items that may contain sensitive information. For another example, a company may distribute mobile computing devices, such as personal digital assistants (PDA), to employees to allow employees to access and utilize company data. The company may desire user verification to allow a user to start up the device to prevent unauthorized access to company data in the event the device is lost, stolen or inadvertently given to an unauthorized user.

According to prior methods and systems, each software application has been responsible for authenticating users to verify authorized access. Unfortunately, such application-based authentication results in varying and inconsistent user experience across different applications. Indeed, according to prior methods and systems a given a user often is required to utilize a different authentication procedure or user interface for each software application he/she uses.

It is with respect to these and other considerations that the present invention has been made.

### SUMMARY OF THE INVENTION

Embodiments of the present invention solve the above and other problems by providing an operating system-based user authentication service that operates independently of a computing device or software application requiring verification of a user's identity to operate the device or utilize functionality of the software application. According to aspects of the invention, a given software application for providing functionality to a user or for allowing a user to operate a desired computing device calls an operating system-based authentication service for verifying the user's identity to use the software application functionality or to operate the desired computing device. If the user's identity is verified by the authentication service, the application is notified, and the user is allowed to operate the device or utilize the desired application functionality.

According to one aspect of the invention, a given software application may be populated with VerifyUser API calls at any point in the application's functionality at which user identity verification may be required. For example, a VerifyUser API call may be populated into an electronic contacts application code such that the call will be initiated upon a user's attempt to open a private contacts folder. When selection of a given application's functionality initiates the VerifyUser API call, the call is passed to the local authentication sub-system operated by the operating system of the user's computing device. The local authentication sub-system queries a verification policies database to determine whether the authentication event associated with the particular VerifyUser API call requires user identity verification. If the access/utilization policies set for this authentication event do not require additional user identity verification, the local authentication sub-system returns a value to the application to notify the application that no user identity verification is required. Thus, the user may continue with the desired action.

If a determination is made from the verification policies database that user identity verification is required for the authentication event associated with the VerifyUser API call passed from the application, the VerifyUser API call is passed from the local authentication sub-system to a local authentication plug-in responsible for user identity verification for the associated authentication event. The local authentication plug-in launches a user interface to request credentials from the user. After the user enters his/her credentials, the local authentication plug-in checks the credentials to determine whether the user is authorized to utilize the desired software functionality or to operate the desired computing device.

If the user's identity is verified to use the desired application functionality or to utilize the desired computing device, the local authentication plug-in returns an authorization value to the local authentication sub-system. The local authentication sub-system returns the authorization value to the application to notify the application that the user is properly identified to utilize the desired application functionality or to utilize the desired computing device.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a block diagram showing the architecture of a personal computing device that provides an illustrative operating environment for embodiments of the present invention.

FIG. 2 is a block diagram illustrating interaction between an application and an operating system-based authentication service according to embodiments of the present invention.

FIG. 3 is a simplified block diagram illustrating example user interfaces for obtaining user identity verification credentials according to embodiments of the present invention.

FIG. 4 is a flow diagram showing an illustrative routine for utilizing an operating system-based authentication service for verifying a user's authorization to utilize desired application functionality or to utilize a desired computing device according to embodiments of the present invention.

### DETAILED DESCRIPTION

As briefly described above, embodiments of the present invention are directed to methods and systems for providing an operating system-based user authentication/verification service that operates independently of a computing device or software application requiring verification of a user's identity to operate the device or to utilize functionality of the software application. In the following detailed description, references are made to the accompanying drawings that form a part hereof and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

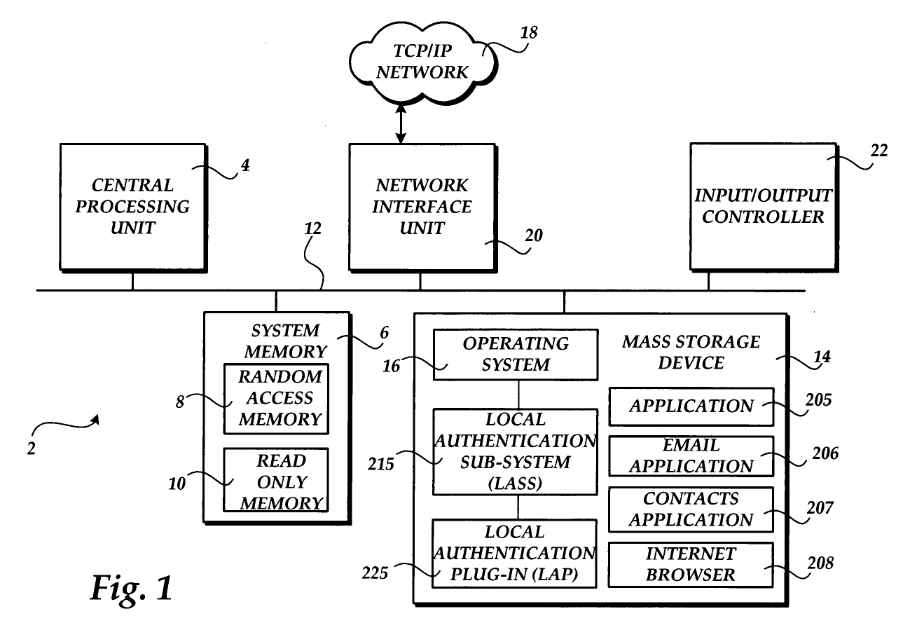

Referring now to the drawings, in which like numerals represent like elements through the several figures, aspects of the present invention and an exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. As should be appreciated, program modules, including computer-executable instructions, for implementing the functionality of the present invention may be stored and distributed according to a variety of computer-readable media including, compact disks, floppy disks, integrated memory storage devices and the like. Likewise the program modules for implementing the functionality of the present invention may be distributed from one computing system to another computing system via distributed computing environments, such as the Internet and intranets.

Those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Turning now to FIG. 1, an illustrative computer architecture for a personal computing device 2 for practicing the various embodiments of the invention will be described. The computer architecture shown in FIG. 1 is illustrative of the computer architecture of a conventional personal computer, a mobile computing device, a personal digital assistant and/or telephony device. The computer architecture shown in FIG. 1 includes a central processing unit 4 (“CPU”), a system memory 6, including a random access memory 8 (“RAM”) and a read-only memory (“ROM”) 10, and a system bus 12 that couples the memory to the CPU 4. A basic input/output system containing the basic routines that help to transfer information between elements within the computer, such as during startup, is stored in the ROM 10. The personal computer 2 further includes a mass storage device 14 for storing an operating system 16, application programs, such as the application program 105, and data.

The mass storage device 14 is connected to the CPU 4 through a mass storage controller (not shown) connected to the bus 12. The mass storage device 14 and its associated computer-readable media, provide non-volatile storage for the personal computer 2. Although the description of computer-readable media contained herein refers to a mass storage device, such as a hard disk or CD-ROM drive, it should be appreciated by those skilled in the art that computer-readable media can be any available media that can be accessed by the personal computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the personal computer 2 may operate in a networked environment using logical connections to remote computers through a TCP/IP network 18, such as the Internet. The personal computer 2 may connect to the TCP/IP network 18 through a network interface unit 20 connected to the bus 12. It should be appreciated that the network interface unit 20 may also be utilized to connect to other types of networks and remote computer systems. The personal computer 2 may also include an input/output controller 22 for receiving and processing input from a number of devices, including a keyboard or mouse (not shown). Similarly, an input/output controller 22 may provide output to a display screen, a printer, or other type of output device.

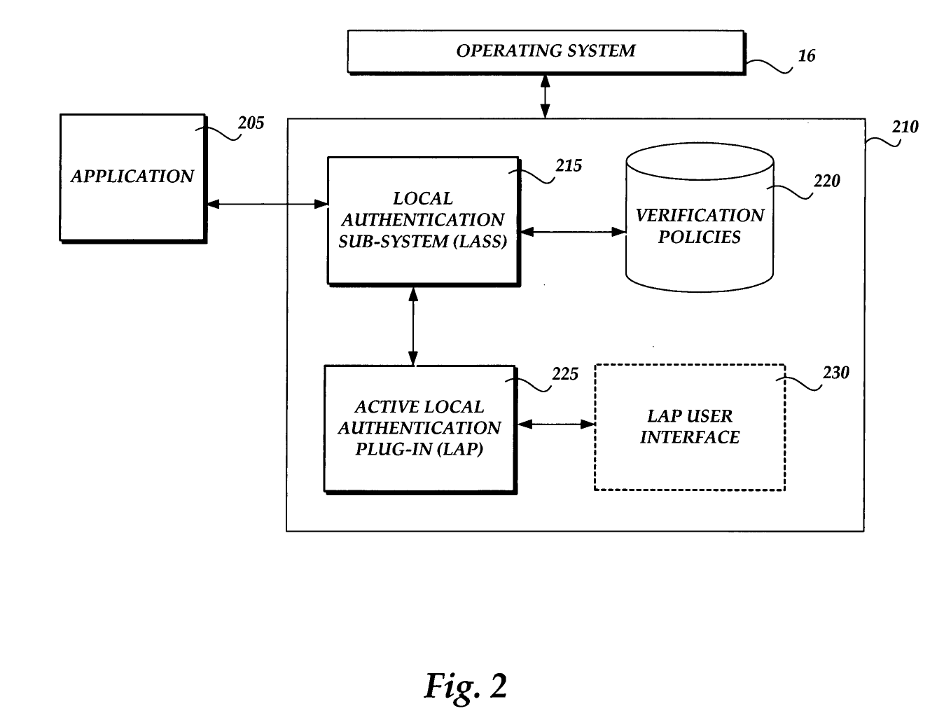

As mentioned briefly above, a number of program modules and data files may be stored in the mass storage device 14 and RAM 8 of the personal computing device 2, including an operating system 16 suitable for controlling the operation of personal computing device, such as the WINDOWS CE operating systems from Microsoft Corporation of Redmond, Wash. As will be described below with respect to FIG. 2, a local authentication sub-system 215 and a local authentication plug-in 225 are shown being functionally related to the operating system 16 for providing the operating system-based authentication service of the present invention.

The mass storage device 14 and RAM 8 may also store one or more application programs. In particular, the mass storage device 14 and RAM 8 may store an application program 105. The application program 105 may comprise a word processing application program, a spreadsheet application, a contact application, and the like. Other applications illustrated in FIG. 1 and applicable to embodiments of the present invention include the electronic mail application 206, the contacts application 207, and the Internet browser application 208. The applications illustrated in FIG. 1 are for purposes of example only, and as will be appreciated, embodiments of the present invention are applicable to any software application including functionality the use of which user identity verification may be required.

FIG. 2 is a block diagram illustrating interaction between an application and an operating system-based authentication service according to embodiments of the present invention. An application 205 is representative of any software application in use by a user on a stationary or mobile computing device such as the computing device 2 illustrated above with respect to FIG. 1. The application 205 is also representative of a software application utilized by a computing device for starting up the computing device such as an operating system 16 responsible for initiating start up of a computing device. For example, the application 205 may be a word processing application, an electronic mail application, a calendaring/contacts application, an Internet browser application, a desktop publishing application, an operating system application, and the like.

According to embodiments of the present invention, developers of the application 205 may insert into the coding of the application 205 application programming interface (API) calls at any position in the coding of the application at which verification of a user's identity to utilize a given functionality of the application may be required. According to one embodiment, the API call is a VerifyUser( ) call that is utilized to call an operating system-based authentication service 210, described below, to verify a user's identity to utilize the desired application functionality. For example, the developer of a contacts application 207 may insert the API call into the coding of the contacts application 207 for requiring verification of a user's permission to open private contacts folders. For another example, a developer of an Internet browser application 208 may insert the API call into the coding of the Internet browser application 207 to require user verification prior to allowing a user to access the Internet.

An API call also may be inserted into the coding of an operating system application 16 to require user verification prior to allowing a user to start up a computing device. For example, a mobile device such as a personal digital assistant (PDA) or a mobile telephone device may be distributed to employees of a company, agency or other institution. The company may be concerned that the device may fall into the hands of an unauthorized user allowing the unauthorized user to access sensitive company information. In order to verify a user's access to functionality of software applications operated on the mobile device or to verify the user's authorization to start up the device, API calls according to embodiments of the present invention may be utilized by the applications including the operating system of the mobile device to require user verification at any time the user initiates certain functionalities of applications operated on the mobile computing device or when the user attempts to start up the mobile computing device.

As should be appreciated, developers of applications 205 and operating system applications 16 may insert the VerifyUser( ) calls into the coding of the applications such that any or all user actions may require verification. As will be described below, the VerifyUser( ) call is passed to the operating system-based authentication service 210, and a parameter of the API call identifies an authentication event associated with the desired user action. For example, if the user is attempting to open a private contacts folder, a VerifyUser( ) call may be passed to the operating system-based authentication service 210 such as VerifyUser(AV_OPEN CONTACTS_PRIVATE), where the AV_OPEN CONTACTS_PRIVATE parameter of the API call identifies an authentication event associated with opening a private contacts folder.

Referring still to FIG. 2, the operating system-based authentication service 210 is comprised of a local authentication sub-system (LASS) 215, a verification policies database 220, at least one local authentication plug-in (LAP) 225 and an LAP user interface 230. The components of the operating system-based authentication service 210 are operated by the operating system 16 of the local computing device 2, and accordingly, individual applications 205 are not required to operate their own authentication methods because all authentication requests are sent to and performed by the operating system-based authentication service described herein.

When a user action with respect to the application 205 or operating system 16 implicates a VerifyUser( ) call where for example the developer of the application 205 requires user identity verification prior to allowing initiation or performance of the desired user action, the VerifyUser( ) call is passed to the local authentication sub-system (LASS) 215 along with a parameter identifying an authentication event associated with the desired action. For example, as set forth above, if the user attempts to open a private contacts folder, a VerifyUser( ) call with a parameter identifying an authentication event associated with opening the private contacts folder may be sent to the LASS 215. According to embodiments of the present invention, the LASS 215 uses the authentication event parameter received from the application to query the verification policies database 220 to determine whether the user has permission to initiate or perform the desired action.

According to embodiments of the present invention, the verification policies database 220 includes policies set by the owner/operator of-the application 205 or local computing device 2 that dictate which functionality of the application 205, operating system 16 or local computing device 2 may be utilized by the user with or without user identity verification. For example, the owner/operator of a contacts application 207 may authorize a given user to open certain private contacts folders without user identity verification, but the policies set by the owner/operator may dictate that a given user may not operate certain other private contacts folders without user identity verification. As should be understood, the owner/operator of a given application 205 or operating system 16 may set policies in the verification policies database 220 associated with any or all functionality associated with the application 205 or operating system 16. That is, a VerifyUser( ) call may be implemented for any functionality available under any application where an owner/operator of a given application may desire user identity verification.

If the verification policies associated with a given authentication event passed to the LASS 215 with the VerifyUser( ) call require that the user must provide authentication credentials before being allowed to utilize the associated functionality, the LASS 215 passes the VerifyUser( ) API call and the identified authentication event parameter to the local authentication plug-in (LAP) 225. The LAP 225 launches a user interface 230 to the user to request authentication credentials from the user. Once the LAP 225 receives authentication credentials from the user, the LAP 225 compares the received credentials with credentials for the user maintained at a suitable storage location for maintaining credentials associated with the user. If the user supplies appropriate credentials, the LAP 225 passes a user verified value, such as “TRUE,” to the LASS 215, and the LASS 215 notifies the application 205 that the user may continue with the desired or selected action.

In addition, the local authentication sub-system (LASS) 215 may be utilized to authenticate a user based on other use parameters. For example, a verification policy for a given application functionality may require that a user must be authenticated after every ten uses of the functionality. For another example, a verification policy may require that a user must be authenticated based on time of use, for example, every 24 hours. Accordingly, when such authentication parameters are associated with a given authentication event, the LASS 215 may track the use of an associated functionality and require authentication at an appropriate time or in an appropriate sequence. For example, if authentication is required after every ten uses of a given functionality, each time a VerifyUser( ) call is received by the LASS for such an authentication event, the LASS 215 may determine whether authentication is now required based on the number of uses, the time of use, and the like for the associated application functionality.

According to embodiments of the present invention, the local authentication plug-in 225 is representative of a plurality of software modules that may be utilized by the operating system-based authentication service 210 for authenticating users according to different authentication methods. For example, one local authentication plug-in 225 may be utilized for passing a simple user interface to the user for requesting a password, user ID, personal identification number, and the like. Another local authentication plug-in 225 may be utilized in association with a fingerprint scanner whereby a user may be required to place his index finger, for example, onto a fingerprint scanner. Other types of local authentication plug-ins may be associated with access card readers, retinal scanners, voice readers, and the like. Accordingly, if an owner/operator of a given software application 205 requires users of the application to authenticate using a fingerprint scanner, for example, a local authentication plug-in 225 for use in association with a fingerprint scanner will be utilized.

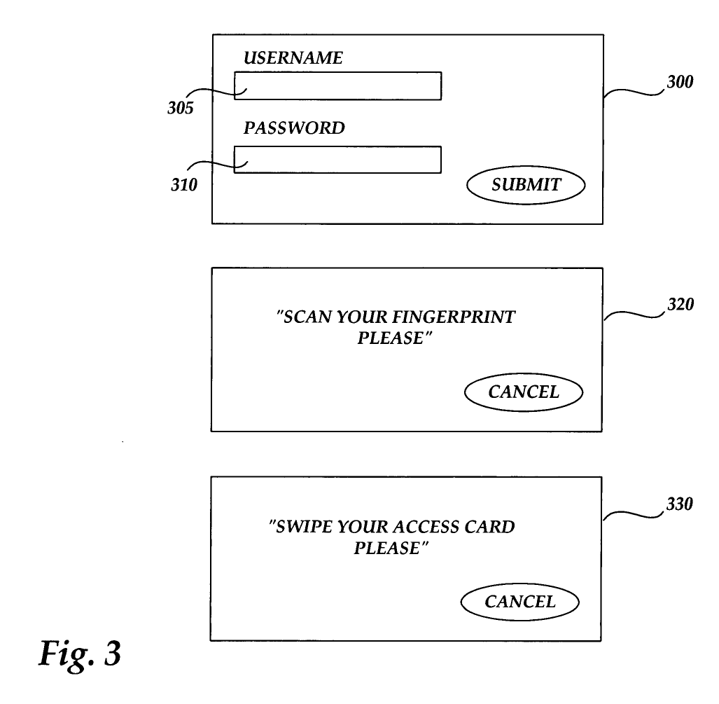

FIG. 3 is a simplified block diagram illustrating example user interfaces for obtaining user identity verification credentials according to embodiments of the present invention. As set for the above, depending upon the type of local authentication plug-in 225 utilized by the operating system-based authentication service 210, a plurality of different LAP user interfaces may be presented to the user to request user identity verification credentials. Referring to FIG. 3, one example user interface that may be presented to a user includes the user interface 300 having a user name field 305 and a password field 310. Once the local authentication plug-in 225 determines that authentication credentials are required from the user, the user interface 300 may be presented to the user to allow the user to enter a user name and password to submit to the LAP 225 for authentication. If the LAP 225 utilizes a fingerprint scanner, for example, a user interface 320 may be presented to the user to alert the user to scan the user's fingerprint. Another example user interface 330 is illustrated whereby the LAP 225 requires the user to swipe an access card. As should be appreciated, other methods may be used for requesting user credentials. For example, instead of a user interface 230, 300, 320, 330, the LAP 225 may cause an audible credentials request to be presented to a user over a speaker device associated with the user's computing device 2.

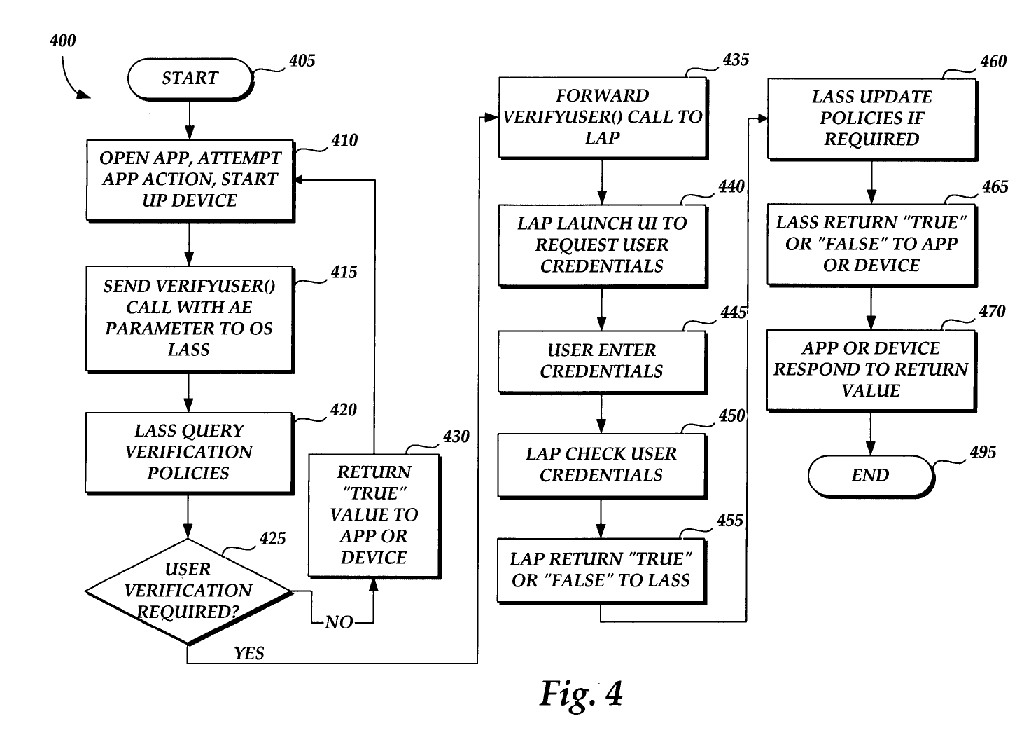

Having described an exemplary environment and system architecture for embodiments of the present invention with reference to FIGS. 1-3 above, FIG. 4 is a flow diagram showing an illustrative routine for utilizing an operating system-based authentication service for verifying a user's authorization to utilize desired application functionality or to utilize a desired computing device according to embodiments of the present invention. The routine 400 begins at start block 405 and proceeds to block 410 where a user attempts to open an application 205, attempts a given application action, or attempts to start up or otherwise utilize a computing device. For purposes of example, consider that a VerifyUser( ) call has been populated by the developer of the application utilized by the user which is implicated by the application action attempted by the user at block 410.

At block 415, the VerifyUser( ) call with an authentication event parameter associated with the action being attempted by the user is passed to the local authentication sub-system 215 of the operating system-based authentication service 210. For example, if the user is attempting to open an electronic mail message containing sensitive information, a VerifyUser( ) call may be implicated such as VerifyUser(AE_OPEN EMAIL ENTRY). At block 420, the LASS 215 receives the VerifyUser( ) call and queries the verification policies database 220 to determine whether any verification policies have been set for the authentication event identified by the parameter passed with the VerifyUser( ) call. At decision block 425, a determination is made as to whether user verification for the identified authentication event is required. If a determination is made is that user verification is not required, for example where the owner/operator of the application in use by the user has set a policy in the verification policies database that allows the user to open electronic mail entries without user verification, the routine proceeds to block 430. At block 430, the LASS 215 returns a user verified value (for example, a value of “TRUE”) to the application 205 to notify the application 205 that the user may utilize the selected functionality. The routine then proceeds back to block 410 where the user may use/perform the desired action and may attempt additional or different application actions or different uses of the computing device.

If user identity verification is required for the authentication event associated with the user's action, the routine proceeds to block 435, and the VerifyUser( ) call along with the parameter associated with the authentication event is forwarded to the LAP 225. The LAP 225 launches an LAP user interface 230 to request user credentials. As set forth above, depending upon the type of LAP 225 implicated by the authentication event associated with the user action in question, one of a plurality of different user interfaces may be presented to the user at block 440. For example, the LAP 225 may present a basic user interface 300 illustrated in FIG. 3 requiring the user to enter a user name and password. If the LAP 225 is associated with a fingerprint scanner, the LAP 225 may present a UI 320 asking the user to scan the user's fingerprint.

At block 445, the user enters credentials as required by the user interface presented to the user. At block 450, the LAP 225 checks the credentials entered by the user. For example, if the user enters a user name and password, the LAP 225 may check the user name and password against a database of user names and passwords to determine whether the user has presented authentic credentials. If the LAP 225 is associated with a fingerprint scanner, the fingerprint entered by the user may be compared against a database of user fingerprints to determine whether the fingerprint entered by the user properly authenticates this user for access to the desired application functionality.

At block 455, if the user has entered appropriate authentication credentials, the LAP 225 may return to the LASS 215 a user verified value such as “TRUE” to notify the LASS 215 that the user has been properly authenticated and may proceed with the desired action. On the other hand, if the credentials provided by the user are not correct, the LAP 225 may return a user not verified value such as “FALSE” to the LASS 225 to notify the LASS 225 that the user may not continue with the desired application action. At block 460, the LASS 225 may update the verification policies stored in the verification policies database 220, if required. For example, if the verified use of a given action is based on a set number of uses, for example verification after every ten uses, the verification policies may be updated to increment the number of verified uses that have been authenticated by the user.

At block 465, the LASS 215 returns the user verification value, for example “true” or “false,” to the application 205 that initiated the VerifyUser( ) call. At block 470, the application 205 responds to the returned value. For example, if a return value associated with a verified user is returned to the application, the application may allow the user to utilize the desired or selected functionality without further delay. On the other hand, if a value is returned to the application indicating that the user is not verified, the application may present an error message to the user notifying the user that the desired or selected functionality may not be utilized or accessed by the user. For example, if the user is attempting to open an electronic mail message associated with sensitive information, and the user is not verified, an error message may be presented to the user notifying the user that the user may not open the electronic mail message selected by the user.

As described herein, methods and systems of the present invention provide an operating system-based user authentication service that operates independently of a computing device or software application requiring verification of a user's identity to operate the device or utilize functionality of the software application. Because the authentication service operates independently of a given computing device or software application, individual software applications are not required to provide individual authentication services which may create varying and/or inconsistent user experiences across different applications and computing devices. It will be apparent to those skilled in the art that various modifications or variations may be made in the present invention without departing from the scope or spirit of the invention. Other embodiments of the invention will be apparent to those skilled in the art from consideration of the specification and practice of the invention described herein.

We claim:

1. A method of verifying a user's identity to utilize a software application functionality, comprising:
initiating a functionality of a software application;
passing an application programming interface (API) call from the software application to an authentication service independent of the software application to determine whether initiation of the functionality is authorized based on verification of user identity;
at the authentication service, determining whether the functionality may be initiated without user identity verification; and
if the functionality does not require user identity verification, notifying the software application that the functionality may be initiated without user identity verification.

2. The method of claim 1, whereby if the functionality does require user identity verification, requesting by the authentication service authentication credentials from the user.

3. The method of claim 1, whereby passing the API call to the authentication service includes passing the API call to a local authentication sub-system.

4. The method of claim 3, whereby determining whether the functionality may be initiated without user identity verification includes causing the local authentication sub-system to determine from a verification policies database whether the functionality may be initiated without user identity verification.

5. The method of claim 4, whereby passing the API call to the authentication service includes passing a parameter identifying the functionality.

6. The method of claim 5, whereby passing a parameter identifying the functionality includes passing an API call parameter identifying an authentication event associated with the functionality.

7. The method of claim 6, whereby the API call is a VerifyUser( ) call.

8. The method of claim 4, whereby if the functionality does require user identity verification, passing the API call from the local authentication sub-system to a local authentication plug-in module for obtaining authentication credentials from the user.

9. The method of claim 8, whereby passing the API call to the local authentication plug-in module includes passing an API call parameter identifying an authentication event associated with the functionality for which authentication credentials are required.

10. The method of claim 8, further comprising at the local authentication plug-in module, launching a user interface for requesting authentication credentials from the user.

11. The method of claim 8, further comprising at the local authentication sub-system, determining whether user identity verification is required based on a type of use of the functionality.

12. The method of claim 11, whereby determining whether user identity verification is required based on a type of use of the functionality includes determining whether user identity verification is required based on an elapsed time of use of the functionality by the user.

13. The method of claim 11, whereby determining whether user identity verification is required based on a type of use of the functionality includes determining whether user identity verification is required based on a number of past uses of the functionality by the user.

14. The method of claim 10, further comprising:
receiving at the local authentication plug-in module authentication credentials from the user; and
determining at the local authentication plug-in module whether the authentication credentials verify the user's identity to initiate the functionality.

15. The method of claim 14, whereby determining at the local authentication plug-in module whether the authentication credentials verify the user's identity to initiate the functionality includes comparing the received authentication credentials against known authentication credentials for the user.

16. The method of claim 14, whereby if the user's identity to initiate the functionality is verified, at the local authentication sub-system (LASS), notifying the application that the user's identity to initiate the functionality is verified.

17. The method of claim 16, whereby notifying the application from the LASS that the user's identity to initiate the functionality is verified includes returning a user verified value to the application in response to the API call.

18. The method of claim 14, whereby if the user's identity to initiate the functionality is not verified, notifying the application from the LASS that the user's identity to initiate the functionality is not verified.

19. The method of claim 18, whereby notifying the application that the user's identity is not verified includes returning a user not verified value to the application in response to the API call.

20. A method of authenticating a user's identity to utilize a software application functionality, comprising:
initiating a functionality of a software application;
passing an application programming interface (API) call from the software application to a local authentication sub-system of an authentication service independent of the software application to determine whether initiation of the functionality is authorized;
at the local authentication sub-system (LASS), determining from a verification policies database whether the functionality may be initiated without user identity verification;
if the functionality requires user identity verification, passing the API call from the local authentication sub-system to a local authentication plug-in module for obtaining authentication credentials from the user;
receiving at the local authentication plug-in module authentication credentials from the user; and
determining at the local authentication plug-in module whether the authentication credentials verify the user's identity to initiate the functionality.

21. The method of claim 20, whereby if the user's identity to initiate the functionality is verified, notifying the application from the LASS that the user may initiate the functionality.

22. The method of claim 21, whereby determining at the local authentication plug-in module whether the authentication credentials verify the user's identity to initiate the functionality includes comparing the received authentication credentials against known authentication credentials for the user.

23. The method of claim 20, whereby passing the API call to the local authentication sub-system includes passing a parameter identifying an authentication event associated with the functionality.

24. The method of claim 23, whereby the API call is a VerifyUser( ) call.

25. The method of claim 20, prior to receiving at the local authentication plug-in module authentication credentials from the user, further comprising launching a user interface from the local authentication plug-in module for requesting authentication credentials from the user.

26. A user authentication system operating independently from a software application in use by a user, the authentication system for authenticating a user's identity to utilize one or more functionalities of the software application, comprising:
a local authentication sub-system operative
to receive an application programming interface (API) call from the software application to determine whether an initiation of a given software functionality by a user is authorized;
to determine from a verification policies database whether the functionality may be initiated without user identity verification;
to pass the API call to a local authentication plug-in module for obtaining authentication credentials from the user if the functionality requires user identity verification;
the local authentication plug-in module operative
to request and receive authentication credentials from the user; and
to determine from the received authentication credentials whether the user identity is verified to initiate the functionality.

27. The system of claim 26, whereby the local authentication sub-system is further operative to notify the application that the user's identity is verified.

28. The system of claim 26, whereby the local authentication plug-in module is further operative to launch a user interface for requesting authentication credentials from the user prior to receiving authentication credentials from the user.

29. The system of claim 26, whereby the API call is a VerifyUser( ) call.

30. A computer-readable medium containing computer-executable instructions which when executed by a computer perform a method of authenticating a user's identity to utilize a software application functionality, comprising:
initiating a functionality of a software application;
passing an application programming interface (API) call from the software application to a local authentication sub-system of an authentication service independent of the software application to determine whether initiation of the functionality is authorized;
at the local authentication sub-system, determining from a verification policies database whether the functionality may be initiated without user identity verification;
if the functionality requires user identity verification, passing the API call from the local authentication sub-system to a local authentication plug-in module for obtaining authentication credentials from the user;
receiving at the local authentication plug-in module authentication credentials from the user; and
determining at the local authentication plug-in module whether the authentication credentials verify the user's identity to initiate the functionality.

31. The computer-readable medium of claim 30, the method further comprising notifying the application from the local authentication sub-system that the user may initiate the functionality if the user's identity to initiate the functionality is verified.

32. The computer-readable medium of claim 30, whereby determining at the local authentication plug-in module whether the authentication credentials verify the user's identity to initiate the functionality includes comparing the received authentication credentials against known authentication credentials for the user.

33. The computer-readable medium of claim 30, whereby passing the API call to the local authentication sub-system includes passing a parameter identifying an authentication event associated with the functionality.

34. The computer-readable medium of claim 33, whereby the API call is a VerifyUser( ) call.

35. The computer-readable medium of claim 30, prior to receiving at the local authentication plug-in module authentication credentials from the user, further comprising launching a user interface from the local authentication plug-in module for requesting authentication credentials from the user.
